(19) United States
(12) Patent Application Publication
(10) Pub. No.: US 2018/0343422 A1
(43) Pub. Date: Nov. 29, 2018

(54) NON-DESTRUCTIVE INSPECTION DEVICE COMPRISING A REMOTE DISPLAY SYSTEM

(71) Applicant: Airbus Operations S.A.S., Toulouse (FR)

(72) Inventors: Aurelien Rautureau, Blagnac (FR); Frédéric Bertrand, Colomiers (FR); Olivier Daffos, Fontenilles (FR)

(73) Assignee: Airbus Operations S.A.S., Toulouse (FR)

(21) Appl. No.: 15/978,416

(22) Filed: May 14, 2018

(30) Foreign Application Priority Data
May 23, 2017 (FR) 17 54563

(51) Int. Cl. H04N 7/18; G01N 29/44; G01N 27/90; G06F 3/14; G02B 27/01

(52) U.S. Cl. CPC H04N 7/183; G01N 29/44; G01N 27/9046; G02B 2027/0141; G02B 27/0172; G02B 2027/0138; G02B 2027/0178; G06F 3/1423

(57) ABSTRACT

A non-destructive inspection device includes: a probe, a camera configured to film an area of the part inspected by the probe, a first display and a second display system configured to allow a display of at least one image filmed by the camera. This configuration makes it possible to remotely display the area of the part inspected by the probe.

### FIELD OF THE INVENTION

The present application relates to a non-destructive inspection device comprising a remote display system.

### BACKGROUND OF THE INVENTION

According to one known embodiment, illustrated in FIG. 1, a non-destructive inspection device 10 used to inspect a part 12 comprises:

a probe 14 configured to transmit a transmission signal, such as, for example, an ultrasound wave in the case of an ultrasound inspection (UT) or a magnetic field in the case of an eddy current inspection (CF) and to receive a return signal generated in response to the transmission signal,

a unit 16 configured to generate the transmission signal and process the return signal, the unit 16 being equipped with a screen 18 to display a result which is based on the transmission and return signals, and

a cable 20 which links the probe 14 and the unit 16, suitable for transmitting the transmission and return signals between the probe 14 and the unit 16.

In operation, after having parameterized the unit 16, an operator holds the probe 14 against the part 12 and directly views the result on the screen 18 as well as the area of the part 12 inspected by the probe 14 to see the result associated with the area of the part 12 inspected. Consequently, the unit 16 must be positioned close to the area of the part 12 inspected and the operator has to be able to watch 22 the area inspected by the probe 14, which may entail bringing his or her head as close as possible to the area of the part 12 inspected.

This procedure is unsatisfactory, in particular because of the discomfort to the operator when performing an inspection in fairly inaccessible areas limiting his or her movement.

### BRIEF SUMMARY OF THE INVENTION

Aspects of the present invention may remedy the drawbacks of the prior art.

One subject of the invention is a non-destructive inspection device which comprises:

a probe configured to transmit at least one transmission signal and to receive, in operation, a return signal generated in response to the transmission signal,

a generator configured to generate the transmission signal,

a return signal processing system configured to produce a result which is based on a processing of the return signal and

a first display system configured to display the result.

According to an embodiment of the invention, the non-destructive inspection device comprises a camera configured to film an area inspected by the probe and a second display system configured to allow a display of at least one image filmed by the camera.

According to an aspect of the invention, the operator does not need to directly view the area inspected by the probe. He or she can stand away from the area inspected, which helps to reduce the arduousness of the inspection in fairly inaccessible areas.

According to other features taken in isolation or in combination:

the probe comprises an energy storage system;

the non-destructive inspection device comprises a unit which incorporates the generator of the transmission signal and the return signal processing system and the probe and the unit are linked by a wireless link;

the unit and the second display system are linked by a wireless link;

the camera and the second display system are linked by a wireless link;

the first and second display systems comprise a pair of augmented reality glasses, configured to display at least one image of an area inspected by the probe and a result associated with the inspected area;

the pair of augmented reality glasses comprises a parametrizing system for remotely driving the generator of the transmission signal and/or the return signal processing system;

the camera is a camera of wide angle type.

### BRIEF DESCRIPTION OF THE FIGURES

Other features and advantages will emerge from the following description of the invention, a description given purely by way of example, in light of the attached drawings in which:

FIG. 1 is a diagram of a non-destructive inspection device which illustrates an embodiment of the prior art,

FIG. 2 is a diagram of a non-destructive inspection device which illustrates an embodiment according to the invention, and

FIG. 3 is a representation of an implementation of the non-destructive inspection device that can be seen in FIG. 2.

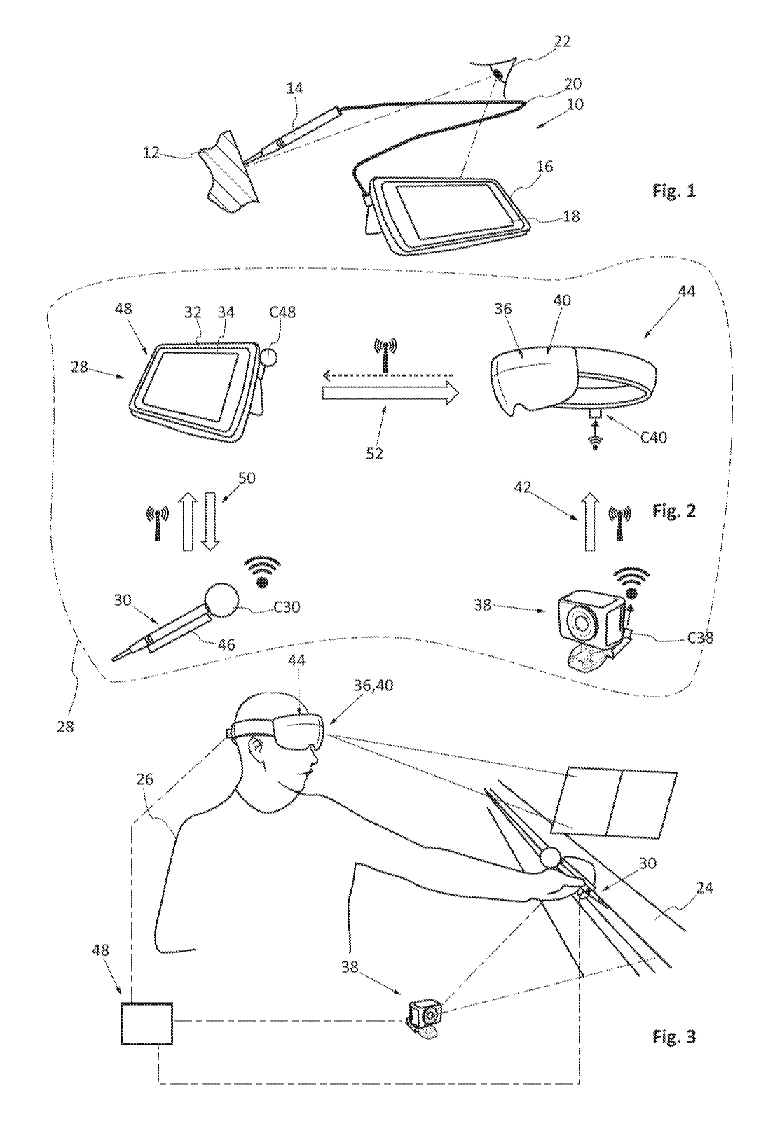

### DETAILED DESCRIPTION

FIG. 3 shows a part of a part 24 to be inspected. According to an application given by way of example, the part 24 is a part of an aircraft.

To inspect this part 24, an operator 26 uses a non-destructive inspection device 28 which comprises:

a probe 30 configured to transmit at least one transmission signal, such as, for example, an ultrasound wave in the case of an ultrasound inspection (UT) or a magnetic field in the case of an eddy current inspection (CF), and to receive a return signal generated in response to the transmission signal,

a generator 32 configured to generate the transmission signal,

a return signal processing system 34 configured to generate a result which is based on a processing of the return signal,

a first display system 36 configured to display the result.

According to a feature, the non-destructive inspection device comprises a camera 38 for filming an area of the part 24 inspected by the probe 30 and a second display system 40 configured to allow a display of at least one image filmed by the camera 38.

The second display system 40 is remote from the inspected area of the part 24.

According to a configuration, the first and second display systems 36 and 40 are arranged close to one another so as to allow the operator 26 to view them directly, without moving.

By having the image filmed by the camera 38 remote, the operator can view, indirectly, the area of the part 24 inspected by the probe 30. He or she can consequently move his or her head away from the area inspected, which helps to improve his or her comfort in the case of a fairly inaccessible inspected area.

According to one embodiment, the camera 38 is a camera of wide angle type for viewing a wide area.

According to another feature, the camera 38 and the second display system 40 are linked by a wireless link 42. To this end, the camera 38 and the second display system 40 each comprise a communication system C38, C40 allowing at least one transfer of data from the camera 38 to the second display system 40. As an example, the communication systems C38, C40 operate according to a communication protocol of WI-FI type. However, the invention is not limited to this type of communication protocol.

According to another feature, the first and second display systems 36 and 40 are one and the same display system. This solution makes it possible to display on the same display system at least one image of an inspected area and a result associated with the inspected area.

According to one embodiment, the display system 36, 40 comprises a pair of augmented reality glasses 44 making it possible to display at least one image of an inspected area and a result associated with the inspected area. This type of display system allows the operator 26 to view the result, the area inspected by the probe 30 and possibly its environment. The pair of augmented reality glasses 44 comprises the communication system C40 for receiving the data from the camera 38.

According to another feature, the probe 30 comprises an energy storage system 46 to make it autonomous energy-wise, such as a battery for example.

According to one embodiment, the generator 32 of the transmission signal and the return signal processing system 34 are incorporated in one and the same unit 48 for generating and processing signals.

The probe 30 and the unit 48 are linked by a wireless link 50. To this end, the probe 30 and the unit 48 for generating and processing signals each comprise a communication system C30, C48 allowing the transmission of signals from the unit 48 to the probe 30 and from the probe 30 to the unit 48. As an example, the communication systems C30, C48 operate according to a communication protocol of WI-FI type. However, the invention is not limited to this type of communication protocol.

According to this embodiment, apart from the communication systems C30 and C48 and the energy storage system 46, the probe 30 and the unit 48 can be identical to those of the prior art.

In addition, the unit 48 and the second display system 40 (in particular the pair of augmented reality glasses 44) are linked by a wireless link 52, using, for example, a WI-FI communication protocol. According to one configuration, the communication system C48 can not only ensure the transmission of data between the unit 48 and the probe 30 but also between the unit 48 and the pair of augmented reality glasses 44. Likewise, the communication system C40 of the pair of augmented reality glasses 44 is configured to allow the reception of the data from the camera 38 and from the unit 48.

By providing a wireless link 50 between the probe 30 and the unit 48 for generating and processing signals, it becomes possible to limit the appearance of spurious signals likely to affect the result.

According to one embodiment, the pair of augmented reality glasses 44 comprises a parametrizing system for remotely driving the generator 32 of the transmission signal and/or the return signal processing system 34.

As illustrated in FIG. 3, the camera 38 is positioned so as to film an area of the part 24 to be inspected. By providing a camera 38 of wide angle type, it is possible to avoid moving it between two inspections on areas of the part 24 that are close to one another. After having set the unit 48 for generating and processing signals, the operator 26 puts on the pair of augmented reality glasses 44 and begins to inspect the part 24, by pressing the probe 30 against the part 24. He or she then views, on the pair of augmented reality glasses 44, not only the image of the area of the part 24 inspected but also the associated result. The unit 48 can be positioned remotely from the area inspected and no longer clutters it up.

This solution makes it possible to reduce the arduousness of the inspection in fairly inaccessible areas, the operator no longer needing to directly view the area inspected. It also reduces the inspection time, particularly in the case of an inspected area that is fairly inaccessible. It also limits the dismantling of parts to allow access to the area of inspection.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A non-destructive inspection device comprising:
a probe configured to transmit at least one transmission signal and to receive, in operation, a return signal generated in response to the transmission signal;
a generator configured to generate the transmission signal;
a return signal processing system configured to produce a result based on a processing of the return signal;
a first display system configured to display the result;
a camera of wide angle type, positioned to film an area inspected by the probe; and
a second display system configured to allow a display of at least one image filmed by the camera.

2. The non-destructive inspection device according to claim 1, wherein the probe comprises an energy storage system.

3. The non-destructive inspection device according to claim 1, further comprising a unit, which incorporates the generator of the transmission signal and the return signal processing system,
wherein the probe and the unit are linked by a wireless link.

4. The non-destructive inspection device according to claim 3, wherein the unit and the second display system are linked by a wireless link.

5. The non-destructive inspection device according to claim 1, wherein the camera and the second display system are linked by a wireless link.

6. The non-destructive inspection device according to claim 1, wherein the first and second display systems comprise a pair of augmented reality glasses configured to display at least one image of an area inspected by the probe and a result associated with the inspected area.

7. The non-destructive inspection device according to claim 6, wherein the pair of augmented reality glasses comprises a parametrizing system for remotely driving the generator of the transmission signal and/or the return signal processing system.
